(19) United States
(12) Patent Application Publication
(10) Pub. No.: US 2014/0067547 A1
(43) Pub. Date: Mar. 6, 2014

(54) SYSTEMS AND METHODS FOR USING TECHNOLOGY TO ENABLE CONSUMERS' PURCHASING POWER IN THE MARKETPLACE

(71) Applicant: DARRELL SCOTT PARK, South Pasadena, CA (US)

(72) Inventor: DARRELL SCOTT PARK, South Pasadena, CA (US)

(21) Appl. No.: 14/017,167

(22) Filed: Sep. 3, 2013

Related U.S. Application Data
(60) Provisional application No. 61/696,712, filed on Sep. 4, 2012.

(51) Int. Cl. G06Q 30/06

(52) U.S. Cl. CPC G06Q 30/0631
USPC 705/14.66

(57) ABSTRACT

Systems and methods can enable individuals to become highly informed consumers with regard to their purchases, including directly at the point of purchase, and can allow them to fully assert their powers of consumer choice on each product or service purchase they consider. Various embodiments also enable consumers to provide individual companies and entire industries direct and clear feedback on why consumers purchased certain products or services and avoided others. Additionally, various embodiments may enable consumers with similar purchase decision criteria to consolidate and summarize their feedback without ever having to organize, meet each other, or interact in any way. Companies can be presented with organized and structured data from regarding consumers' purchasing decisions. In some embodiments, disclosed systems and methods can serve as a marketplace for like-minded consumers and companies to find each other with a reduced effort, thereby substantially empowering consumers and lowering the companies' customer acquisition costs.

### CROSS REFERENCE TO RELATED APPLICATIONS

This application claims priority to provisional U.S. Patent Application No. 61/696,712, filed on Sep. 4, 2012, which is hereby incorporated by reference in its entirety.

### BACKGROUND

150 years ago an individual consumer often had considerable knowledge of the people and companies they purchased goods and services from because often they lived in close proximity, had fewer choices, made fewer purchases, and thus were aware of the smallest details related to their purchases. Consumers could choose not to purchase vegetables from a certain farmer at the weekly market because of the knowledge that this particular farmer engaged in behavior the consumer chose not to support—for example being physically or emotionally abusive to his family. In today's terminology this might be called voting with one's feet or one's dollars. Unfortunately in today's world, it is often nearly impossible for the average consumer to understand where their goods actually come from and who actually makes them. Thus it becomes very difficult to know under what conditions the goods are made, and who profits from the various steps in the transaction, and what these profits are spent on. Although it appears often to be a free market, there is often no easy way for consumers to have the knowledge of the sometimes very complicated world of global supply chains, parent corporations, holding companies, and subsidiaries. If today's consumer can't easily make the link between a single product they purchase and the company behind that product, it becomes very difficult to have empowered consumers, and thus a key driver of free markets is not functioning effectively. Sure, it is possible for consumers and the organizations that support them to hold boycotts against individual products or companies, but given the vast number of companies and products as well as the difficulty in getting useful and timely information to consumers at the time of purchase, most consumers lack the tools to properly assert their free market power as consumers in any meaningful way.

### SUMMARY

The disclosure provided in the following pages describes examples of some embodiments of the invention. The designs, figures, and description are non-limiting examples of some embodiments of the invention. Other embodiments of the system may or may not include the features disclosed herein. Moreover, disclosed advantages and benefits may apply to only some embodiments of the invention, and should not be used to limit the scope of the invention.

In one embodiment, systems and methods assist in ranking products that the user may have established, and more importantly, may present the consumer with information relevant to them at the point of purchase. This can allow the consumer to make a buy/don't buy decision in an informed manner. If the decision is to avoid a particular product or company, one embodiment may offer a mechanism for alternative products and companies to be selected that meet the purchasing criteria of the consumer. It may enable consumers to regain the purchasing power of their money to assert their wishes on the marketplace in order to both spend their money consistent with their personal preferences about company behavior and practice and motivate change among companies and products that have benefited from the lack of transparency and lack of consumer power.

This can be a unique method of using mobile and computer applications to enforce consumers' power in the marketplace from a user generated or selected list based on preferences and be given other preferences based on combination of like or dislike of company actions behavior or and then be steered to similar products from companies that do not.

One of the implementations may use standard bar code scanning functionality with a database that links bar codes on products to companies and these companies to their parent companies may then combined with millions of other data points (such as the number of women on each company's board or the campaign donations made by a particular company, or the location of its facilities). This database may then enable consumers and organizations to recommend that certain companies and their products be either purchased or avoided. In some embodiments, when a user makes or avoids a purchase, this information can be recorded and stored in the database as well as in the application on the users mobile device, computer, tablet computer device or similar equipment. Each list can have a running total of each of the purchases and avoided purchases of the products of the companies associated with it. In one embodiment, for every product or company on the list that is not recommended, there can be a suggested product or products or company instead. Users may be able to make their preferences known in a number of ways. For example, they can notify the company each time a purchase or avoided purchase is made, and if they wish they can share this information publicly, with other subscribers of a particular list or with any subset of people they wish. There may also be a seamless connection to the user's account on social media websites.

In some embodiments, dollar amounts on all made and avoided purchases can be taken by from averages found on the internet, and from other available sources and they may be adjusted by an individual user to reflect the exact cost of their purchase or avoided purchase at the exact time of their transaction.

In another embodiment, systems and methods may enable individual consumers to virtually band together to make their wishes known to companies selling products in the marketplace by voting with their dollars. This can immediately both impact a company's bottom line (positive or negative) and push these companies to understand and act on the wishes of their customers. It can be like a union for individual consumers that may enable the voice of millions of consumers to be grouped together in a way that is so powerful it is difficult to ignore. In some implementations, systems and methods may make it easy to enforce boycotts by recording both the purchases and the avoided purchases. For example, if an organization was trying to dissuade its members from buying products from companies that did not have women on their board, then this group could create a list of products and companies that should be avoided and populate the list so that every product to be avoided has at least one acceptable similar substitute (e.g., not this shampoo, buy this one instead). Then what was purchased and what was avoided can be compiled both at the individual consumer level and aggregated level so that there is great data that can be provided to companies to either reinforce company practices or refute them. It can also be used to support a particular class of products or companies. For instance if micro-brew beer lovers dismay that their beloved small breweries are being purchased by larger beer companies, then they can use the application and the associated databases and connectivity to build a list that steers other microbrew beer lovers away from beers that may appear to be microbrew beers but are owned by large corporations. In some embodiments, all that a user of the application may have to do is create their own list or use a list created by another user and bar code scan a product using their mobile phone and then they can be advised by the application that this is either a product that they should buy or one they should avoid via the graphics and words on the screen. If they are advised to avoid the product, the list can have the capability to suggest a similar product that will potentially meet their needs. In the case of the micro-brew beer purist consumer, after they bar code scanned or typed in the name the beer they were thinking of purchasing, a screen may appear indicating either that the product is indeed a true micro-brew and indicate to the consumer that it is ok to purchase or that this purchase should be avoided. In one implementation, there is a mechanism for recording the purchase and the avoided purchase information and compiling it so identifying information of the user is protected, but also is able to be grouped with others so that the application and those using it can take advantage of the power of numbers in order to help consumers spend their money in accordance with what is important to them.

There is no limitation to the use of these lists. For instance, a list could be compiled by organizations or individuals wishing to buy as many products as possible that are made locally. The data base can then be used to show businesses in the local area how much business was driven by the list and also to encourage businesses outside the local area to either relocate or to expand into the area. Lists could also be created to support small businesses or to help people on diets follow them through. The list for the dieter could either announce it is on the recommended list or suggest an alternative food.

Embodiments have the potential to change the way every corporation does business. It can put the power back in the hands of the consumer through the use of technology, systems and methods. Individual consumers can now have the power to not only make informed decisions about their purchases, but also can have the ability to generate the monetary data related to purchases and avoided purchases that inform companies and industries about why consumers are or are not purchasing their products. Nearly every product sold to consumers in modern society may have a bar code, thus these systems and methods can impact the entire consumer economy. Embodiments are not limited to barcodes and can enable technologies such as global positioning systems (GPS) and other location information to assist the consumer in spending their funds consistent with their wishes. For instance, if a consumer made the selection to avoid a certain place of business such as a restaurant or a store, some embodiments may enable the consumer to be provided with feedback indicating that based on the users location and their consumer preferences that they should probably leave the place of business and can be given directions to acceptable alternatives among a listing of other alternatives, and even receive targeted coupons for these alternatives. For example, a customer can be parked in a parking lot of a business and, based on provided information, decides not to purchase the products or services offered by that business. Instead, the consumer may receive a coupon to a nearby business that provides alternative products or services.

In one embodiment, a filter is added to existing online shopping sites and applications. For example, the filter can be added on top of common online shopping sites and applications. The filter enables users to make online purchases with the same types of relevant information and choice selection, based on their own preferences at the point of purchase, as embodiments that utilize bar code scanning as well as individualized coupons that are coded for use by an individual or an individual's household. In one embodiment, individually targeted coupons and other discounts can be uniquely numbered for each consumer are can be offered and redeemed electronically. Such coupons can incentivize an individual consumer to buy a given product or service while their sharing can be closely monitored and controlled. These targeted coupons can be produced for an individual meeting certain criteria, can be coded for use only by the individual or the individual's household, and can be redeemed at the point of sale (e.g., either in person at a store or online) or directly from the supplier or manufacturer. For example, a coupon can be redeemed by scanning the coupon or typing in the number of the coupon. The unique numbering system of these coupons can enables them to have a nearly unlimited pre-programmed number of uses. For instance a free product can be given when a coupon is used the first time. Then, if the coupon is used again within some give time, the user can get 50% off, then 30% off, etc. Subsequently, the user can buy Y, get one free, then a free one on user's birthday, and the like.

In another embodiment, users are able to learn the business relationships, affiliations, and other relevant information of service providers (e.g., companies and organizations with which users do business) such as, but not limited to, landlords, mortgage bankers, credit card companies, banks, health insurance providers, employers, federal, state and local governments, charities, non-profits, PACs, political candidates, lenders, private equity firms, hedge funds, venture capital firms. Alternatives for such service providers are provided to users, which may include providing individualized coupons, discounts, and special offers for alternative service providers to do business with based on a user's preferences. In one embodiment, for instance, if a user has a mortgage with a company or banking institution that does not support the user's values or things the user cares about, then the user is provided with easy options for switching, including discounts, waived fees, and other non-transferable or limited transferability personalized coupons that are provided uniquely to the individual based on the specific preferences. Alternative service providers also include, but are not limited to, companies such as insurance, banking, health insurance, medical, and other institutions. Advantageously, this substantially lowers the cost of customer acquisition for alternative companies and organizations and serves to raise the overall quality of services at least in part because a customer is provided with more complete information and easy opportunities to switch to service providers based on the criteria that are important to the customer.

In some embodiments, a purchasing recommendation apparatus includes a memory module configured to store a recommended products or services list and a processor having logic circuitry. The processor can be configured to receive an identification of a desired product or service and, in response to determining that 1) the identified product or service is comprised in the recommended products or services list and 2) the identified product or service was purchased, selectively generate one or more electronic coupons and update the recommended products or services list with information corresponding to the purchased identified product or service. The processor can be further configured to, in response to determining that the identified product or service is not comprised in the recommended products or services list, provide a user interface comprising a set of alternative products or services based at least in part on a set of preferences and, in response to determining that an alternative product or service from the set was purchased, update the recommended products or services list with information corresponding to the purchased alternative product or service.

In some embodiments, a purchasing recommendation method includes receiving an identification of a desired product or service from a computing device. The method includes, in response to determining that 1) the identified product or service is comprised in an electronic recommended products or services list and 2) the identified product or service was purchased, selectively generating one or more electronic coupons and updating the recommended products or services list with information corresponding to the purchased identified product or service. The method further includes, in response to determining that the identified product or service is not comprised in the recommended products or services list, providing a user interface comprising a set of alternative products or services based at least in part on a set of preferences and, in response to determining that an alternative product or service from the set was purchased, updating the recommended products or services list with information corresponding to the purchased alternative product or service. The method can be implemented by a processor comprising logic circuitry.

### BRIEF DESCRIPTION OF THE DRAWINGS

The accompanying drawings constitute a part of this disclosure and also helps to explain various embodiments. The drawings described herein and are not intended to limit the scope of the disclosure.

FIG. 1A is an example of a diagram indicating a process and method by which a simple bar code scan of a product by a consumer can turn into substantial high quality data on the purchase and/or the avoided purchase, as well as alternative product suggestions which can be used to enable organizations and individuals to assist in quantifying their impact in the marketplace.

FIG. 1B is an example of a diagram indicating a detailed process and method for feedback that is part of an embodiment enabling consumers and organizations to monetarily quantify their support or lack of support for particular companies and products.

FIG. 1C is an example of a diagram indicating a List Creation and Data Recording Process.

FIG. 1D is an example of a diagram showing a method for reconciling conflicting information between lists (if users include more than one list in their account).

FIG. 2 is an example of a diagram showing one configuration of an implementation an embodiment, including the ability to create lists, subscribe to existing lists, see totals of total purchases, individual purchases and individual avoided purchases.

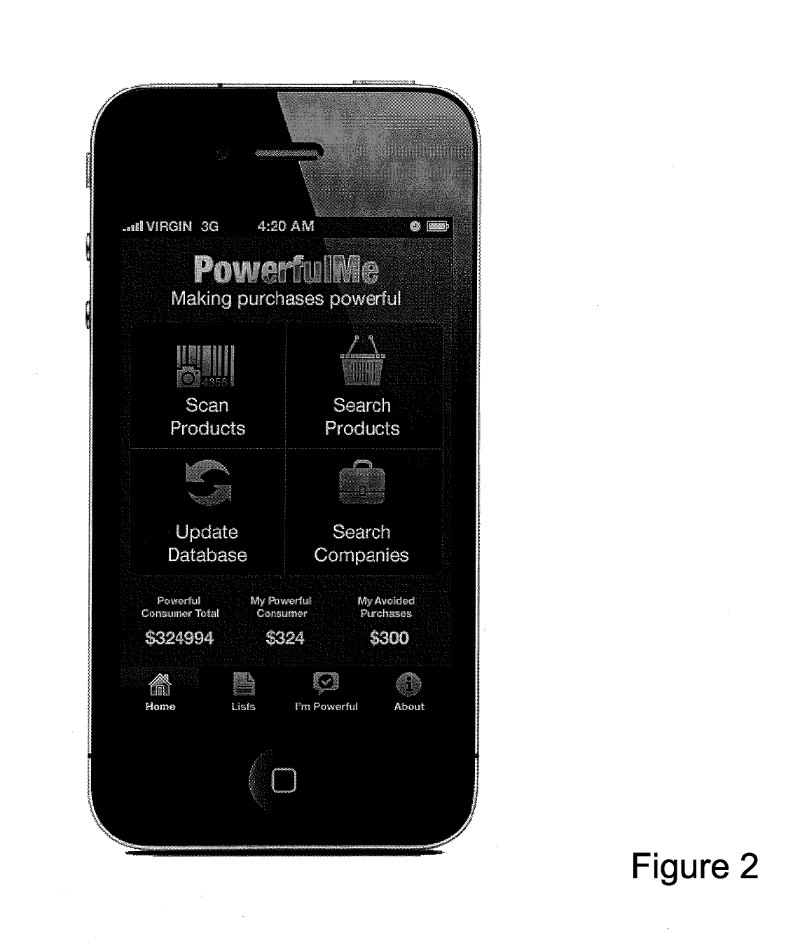

FIG. 3 is an example of a diagram showing one configuration of bar code scanning technology and a configuration that links it to a database with list information as well as company and product data.

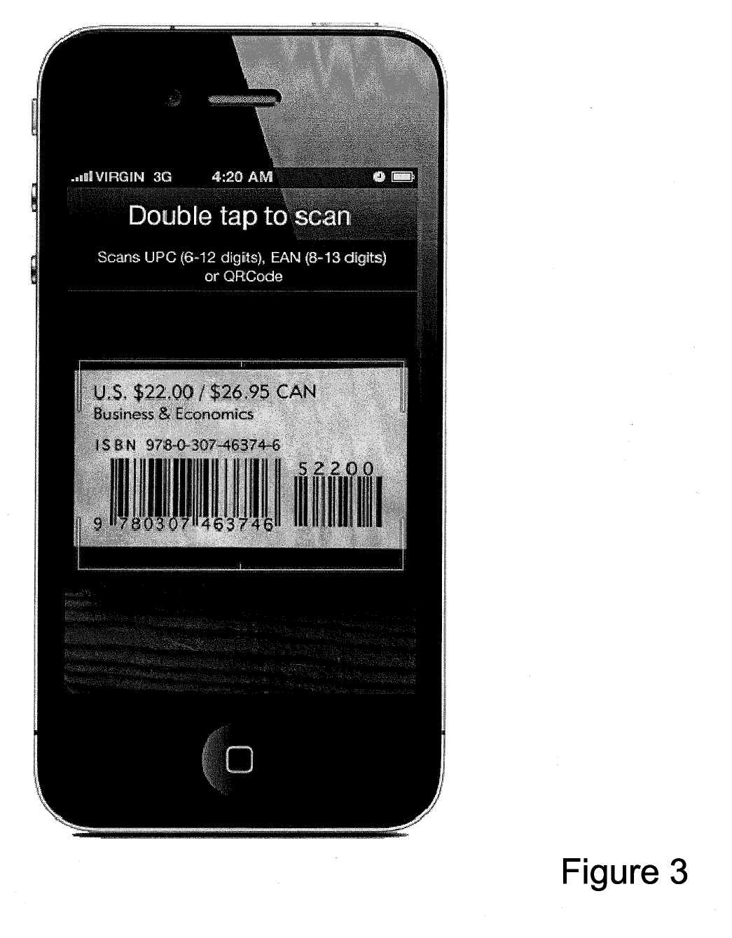

FIG. 4 is an example of a diagram showing one configuration of an action that occurs after a user who subscribes to a list or otherwise receives an indication to avoid a product or company. The diagram includes an indicator that the product or company is on the list to be avoided (this indicator may visual or by sound and also by vibration from the scanning device or another auxiliary device).

FIG. 5 is an example of a diagram showing one configuration of an action that occurs after a user who subscribes to a list or otherwise receives an indication that a given product or company is recommended (this indicator may visual or by sound and also by vibration from the scanning device or another auxiliary device).

FIG. 6 is an example of a diagram showing one configuration of an individual user's personal transaction data that can display relevant data about the purchases and avoided purchases made by the consumer, including dates, monetary amounts per item, totals and other related information.

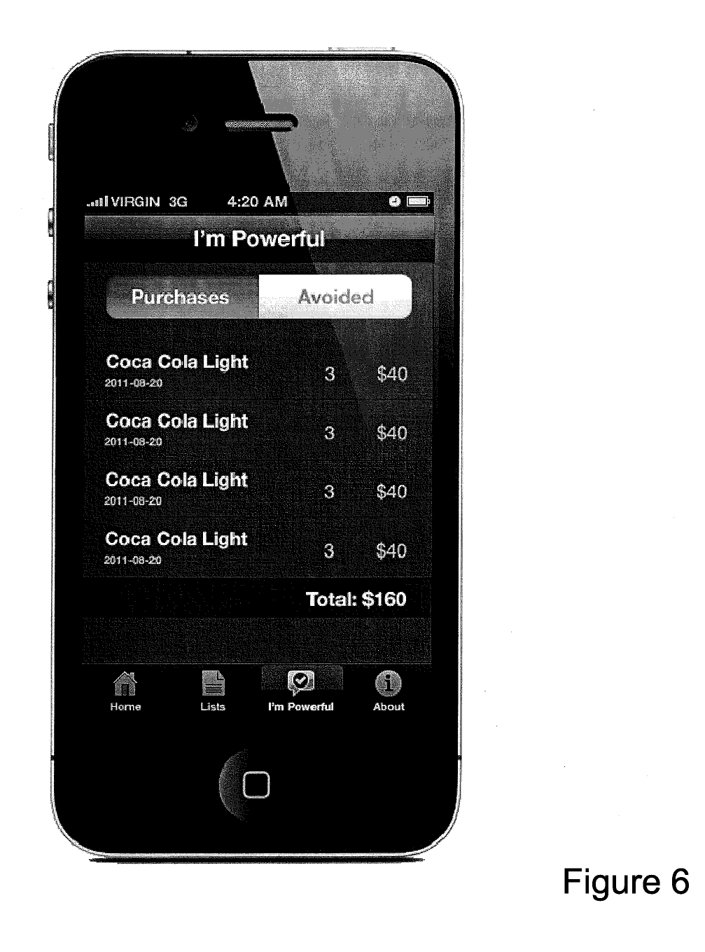

FIG. 7 is an example of a diagram showing one configuration of a list creation, selection, sorting and recommendation main screen. Lists can be the key way by which individual users and organizations can note the companies and products to be avoided and those that are recommended. Lists also may provide the structure under which feedback can be given to companies about their actions and behavior.

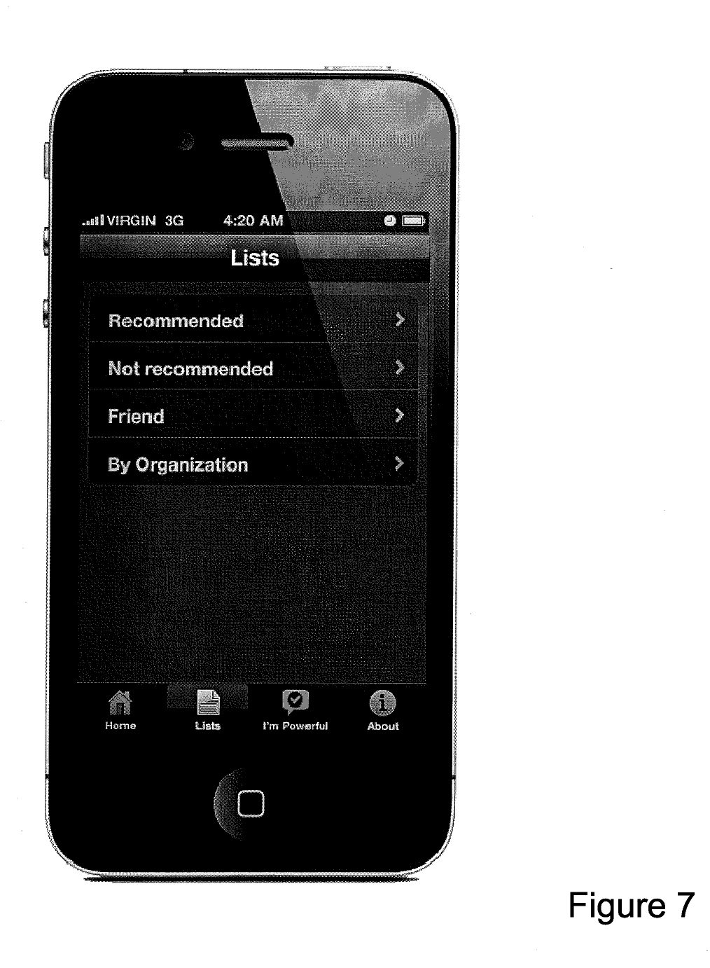

FIG. 8 is an example of a diagram of one configuration of a portal to the database of companies that can display a nearly unlimited number of data points about each company and can note for each individual user or group, based on the lists they have selected, whether the company is recommended or not recommended.

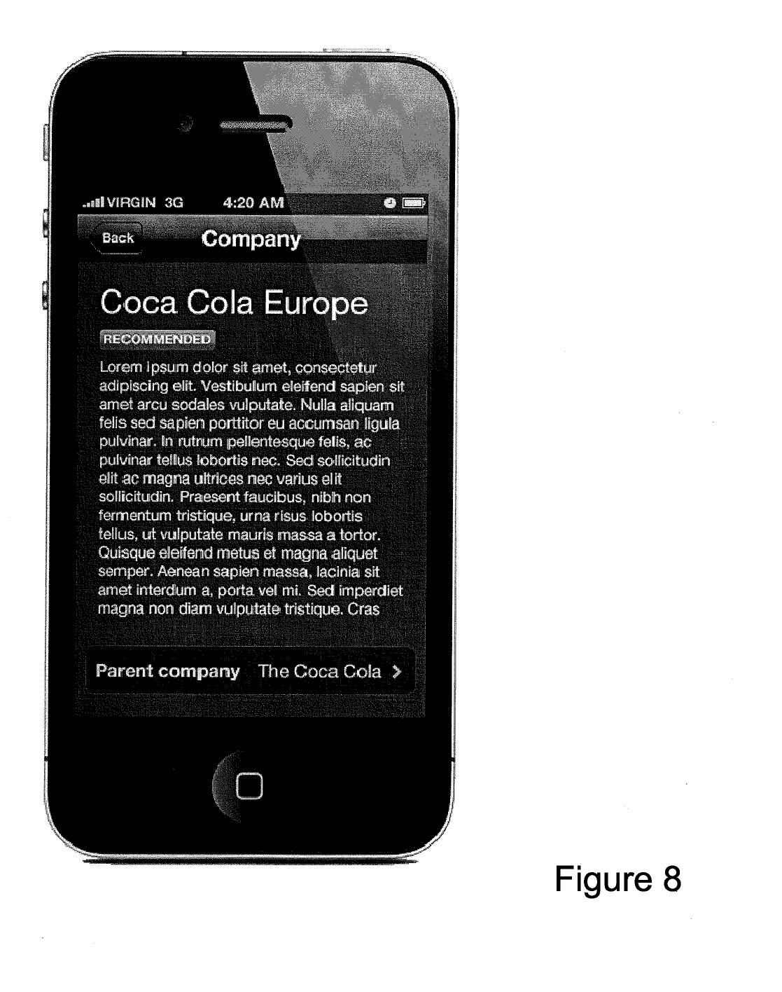

FIG. 9 is an example of a diagram of one configuration of a data entry screen to update information on products, companies, bar codes, substitute products, descriptions, and other related information. This can be a way to update nearly any product or company focused data in the database or to create new records of the same.

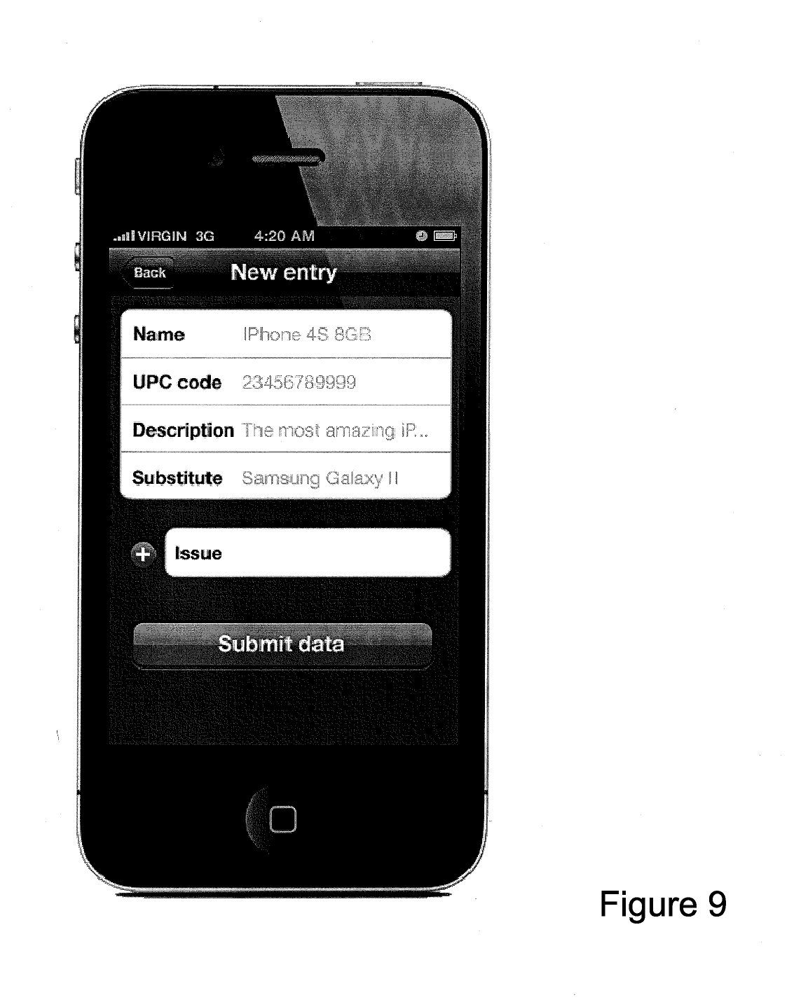

FIG. 10 is an example of a diagram of one configuration of a portal to the database of products that can display a nearly unlimited number of data points about each product and can note for each individual user or group, based on the lists they have selected, whether the product is recommended or not recommended and what the alternatives are.

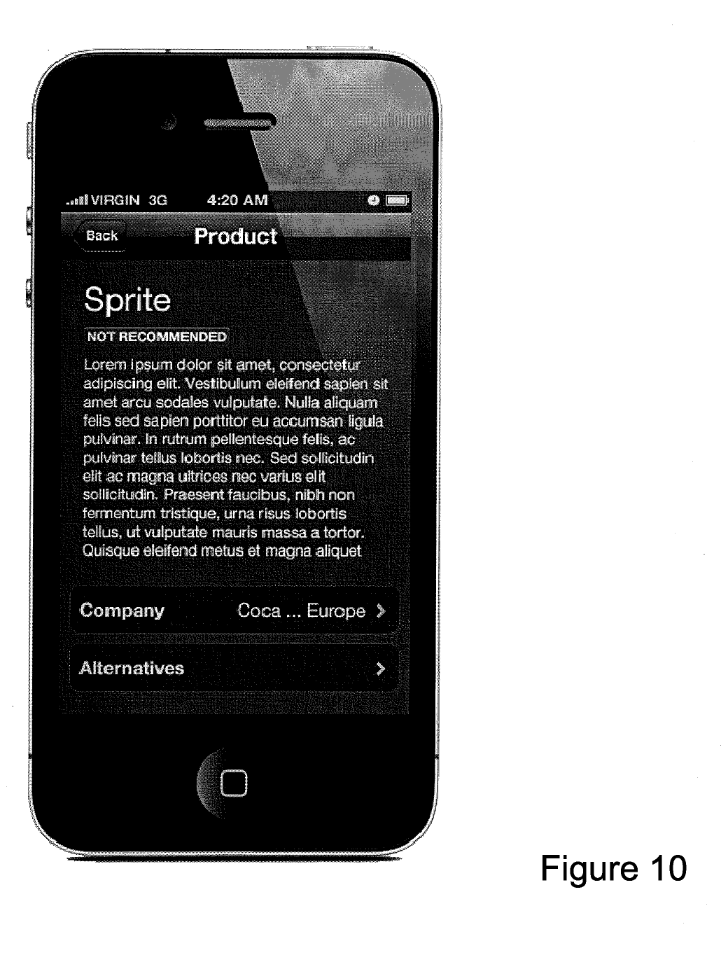

FIG. 11 is an example of a diagram of one configuration of a list created by a user or an organization. In this particular configuration it enables a searchable list of all recommended products, and the same is available for non-recommended companies, alternatives, recommended and not recommended products as well as related data.

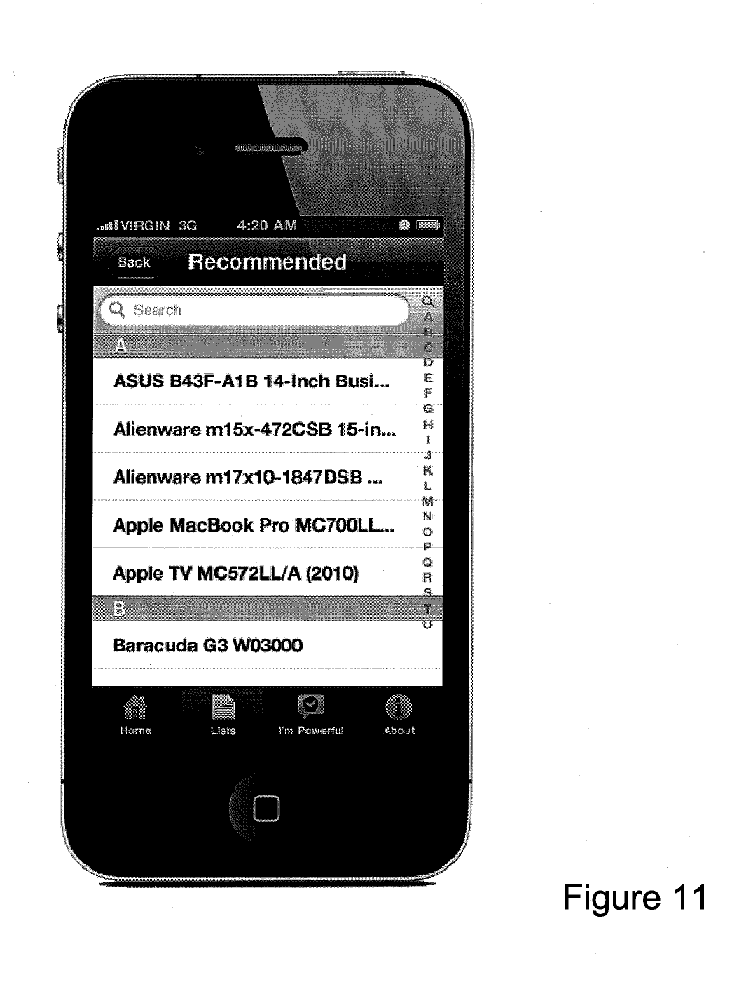

FIG. 12 is an example of a diagram of one configuration of a list of recommended products that enables users and organizations to add or delete any created by a user or an organization and the same is available for non-recommended companies, alternatives, recommended and not recommended products as well as related data.

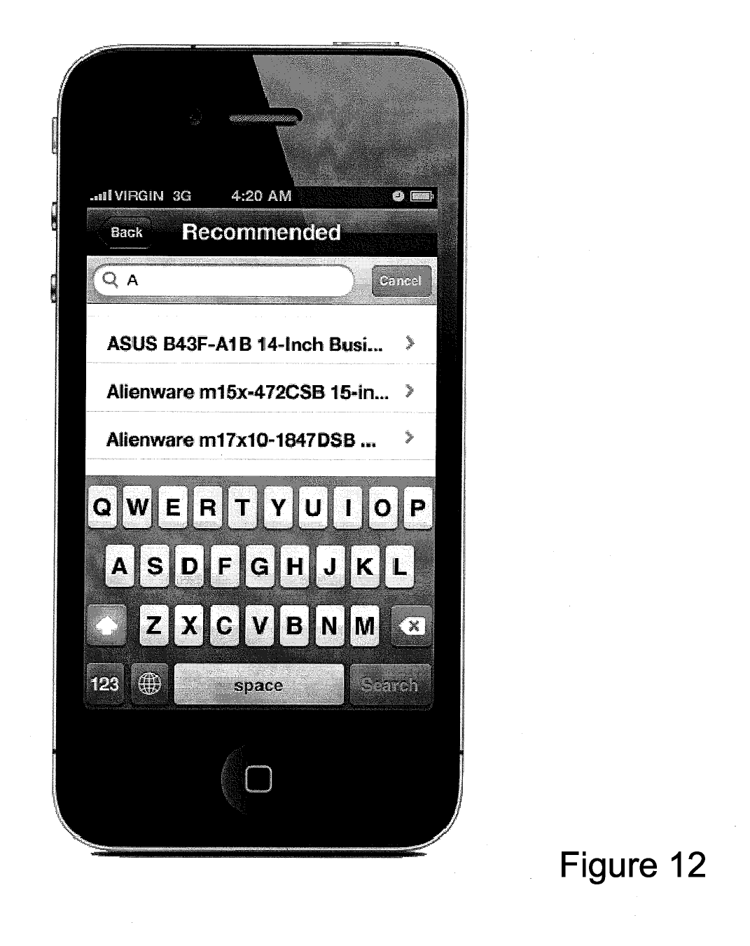

### DETAILED DESCRIPTION OF THE PREFERRED EMBODIMENTS

The following detailed description refers to the accompanying diagrams. The detailed description does not limit the disclosure.

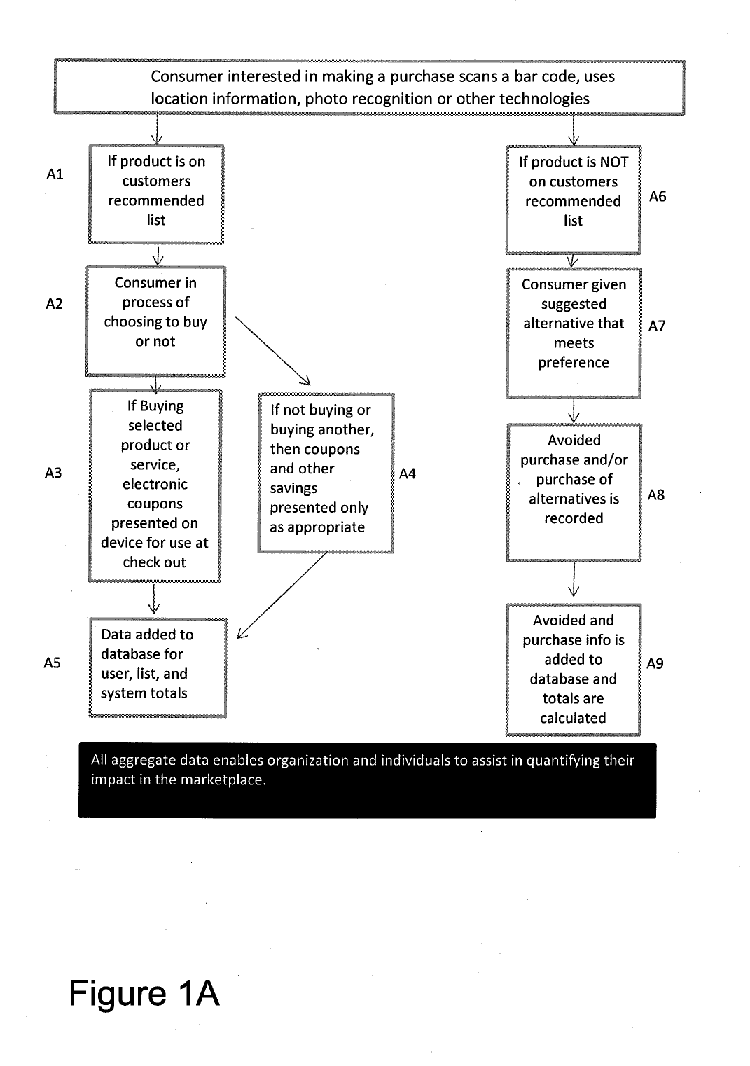

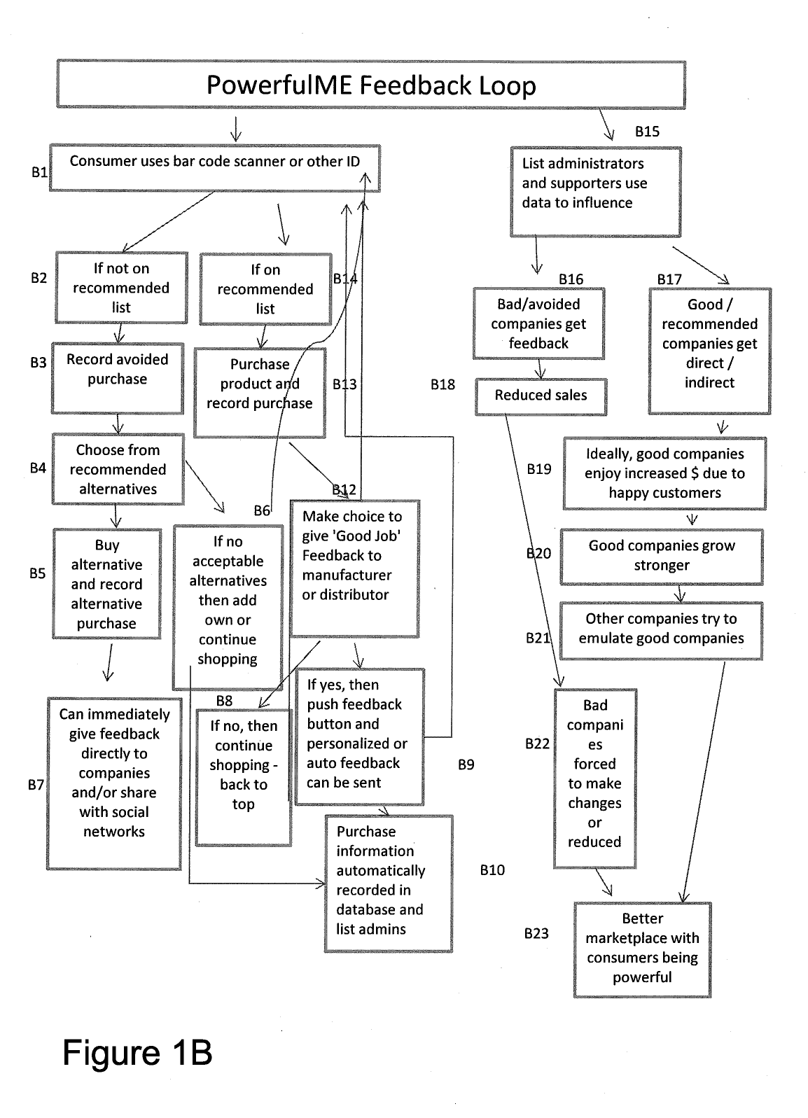

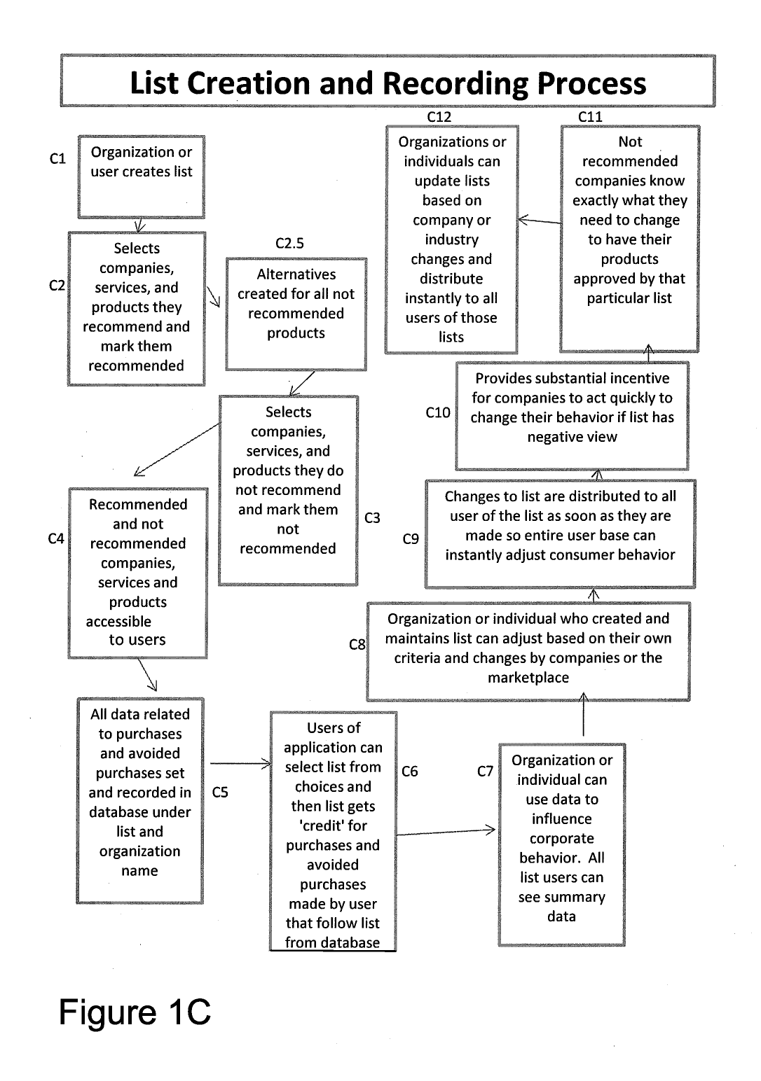

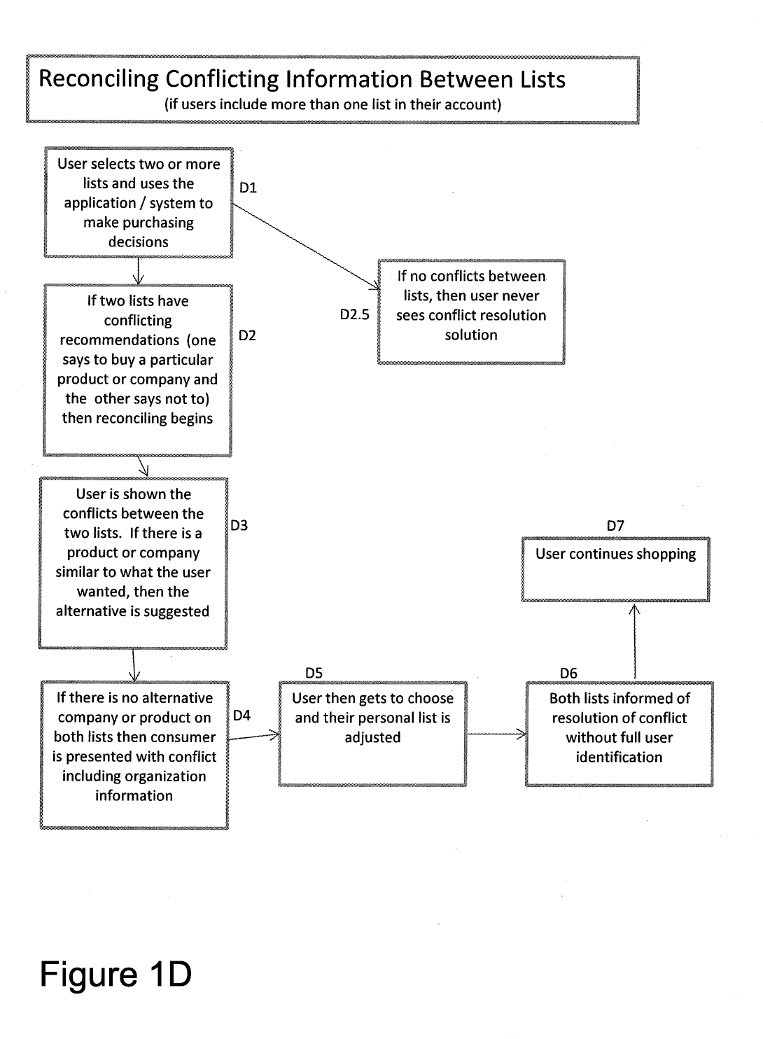

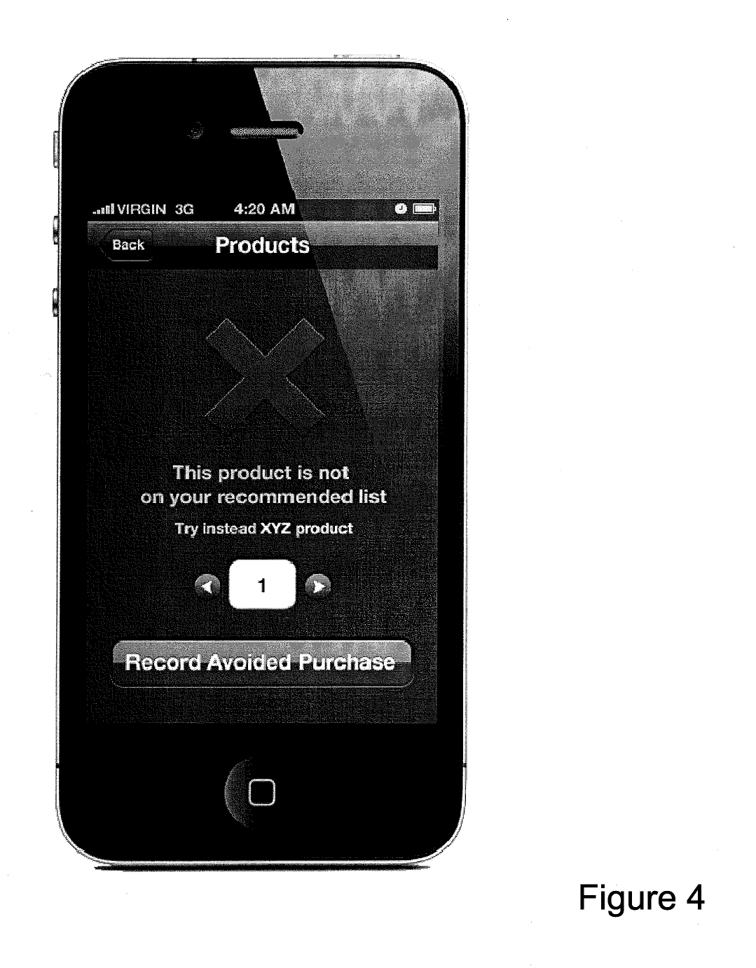

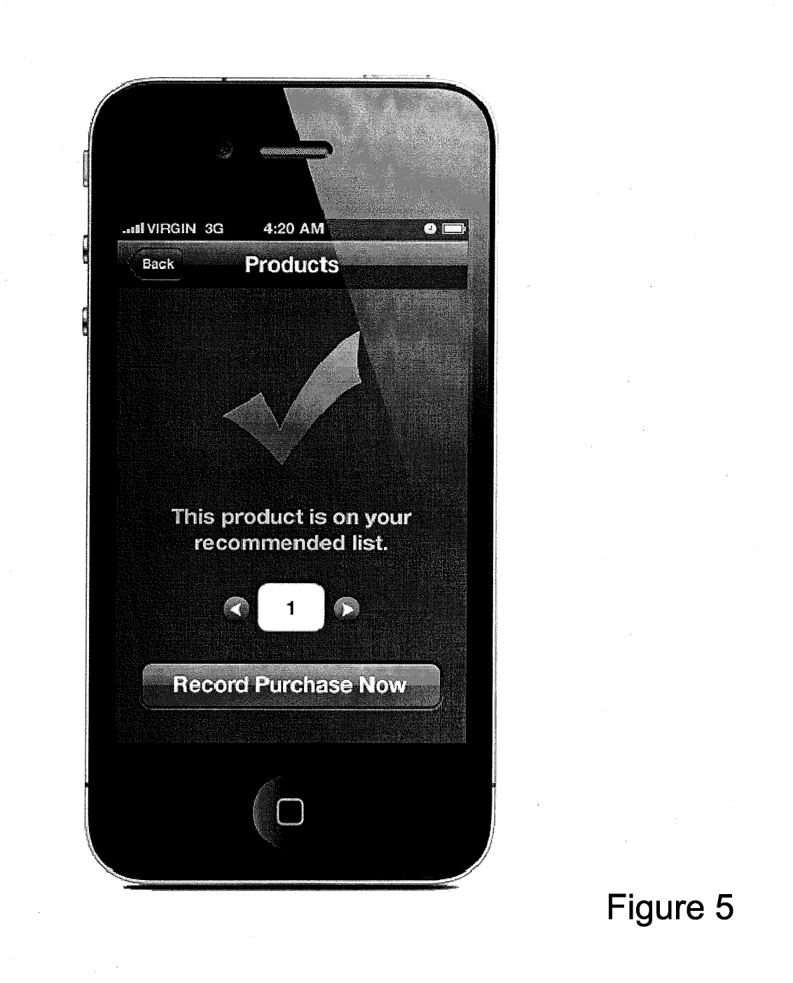

FIG. 1A is an example of a diagram of systems and methods of using lists of companies and products or services for supporting or withholding support from companies. In one implementation, using database technology, mobile computing power and bar code scanning along with the ability to have organizations and individual users create these lists on their own on a nearly unlimited number of themes that recommend products and companies to purchase from and those to avoid (FIG. 1A) can be provided. In one use of the technology a user can scan a bar code using a mobile or stationary device or otherwise identify the product through the bar code number, the company name, the product name or related ways, such as RFID, Quick Response (QR) code scanning, photo recognition of products from a grocery receipt, a TV commercial, an internet advertisement or even a conventional billboard or magazine advertisement, or location information. (A1),(A6) The user can create their own list or subscribe to at least one existing list containing information on what products to purchase and which to avoid, with alternative products and companies for the products and companies to be avoided. Once the product, company and other identifying information have been located in the database, the consumer can be presented with a recommendation from the list(s) they created or subscribe to. The user can be presented with easy to understand visual, audible and or vibrations or movements from the device or technology (A3) (A4) (FIG. 4) (FIG. 5) indicating whether the product or company is recommended or not recommended. If the product is recommended by the list, the user can record the product purchase, including quality and actual purchase price, through an easy to use interface. If the product is not recommended, the user can be informed in a similar format to the recommended products (FIG. 4). Additionally, for non-recommended products, the user can also be informed of alternative products that are recommended by the list that may serve as a substitute for the non-recommended product. The user can be presented with the identifying information on the recommended product and if the user chooses to purchase that product or another from the same company as the recommended alternative product, then the purchase price and other information such as the quantity purchased can be recorded. The user can also add their own alternative and change their own list or suggest the change to the list(s) they subscribe to. Then the user may record the quantity of the avoided product, price at time of avoided purchase, as well as related transactional information (FIG. 4). The user can also choose to make a purchase of a non-recommended product or service and note the reason for doing so as well as update any list they created and send a message to the creator of any list the user did not create, letting them know that they purchased an item on the not recommended list and explaining why and potentially asking the list creator to update their list.

FIG. 1B is an example of a diagram of a feedback loop created and can assist in explaining the importance of sharing of the lists as well as their creation by individuals and groups. These lists can be the basis for categorizing all of the purchases and avoided purchases and the method by which all of the purchase data is recorded and organized. The sharing of lists after they have been created can be a significant part of various embodiments. In some embodiments, each individual can select one or a number of lists that fit with their consumer preferences

FIG. 1C shows the creation of lists by individuals or organizations (C1) so that existing members or supporters of an organization or cause can instantly distribute exact information to their members and supporters (C9) recommending exactly what products should be purchased and which should be avoided. As individual transactions are recorded (C5)—all data related to purchase and avoided purchases may be noted both in the individuals viewing area and in the larger database. Notable other information such as price at the time of the transaction can also be recorded or confirmed (C5). There may be system and methods for database and other functionality that enables the recording and tabulating of both purchases and avoided purchases as well as totals for individual users, list groups, and the total system, sorted by company and a number of other ways (A5). This data can be instantly shared with individual users, creators of lists, companies, industry groups, and the general public in order to facilitate changes desired by consumers and organizations. It can be recorded using the list framework and although it may be sortable by any variable in the database, it can use the list structure as it organizing principle with clearly identifiable reasons for recommending or not recommending products and companies (FIG. 1B) (FIG. 1C). Using this method may serve to group the feedback of potentially millions of individual consumers into very clear and concise points with monetary figures attached. Contacting a company and saying that you didn't buy their product because of something the company did, may have an impact, but being able to group millions of these individual consumers offering unambiguous feedback in the form of monetary transactions, with very little burden to individual users and the potential to change corporate behavior. The act of individual consumers recording their purchases and avoided purchases after creating and subscribing to lists of companies can set in motion a feedback loop show (FIG. 1B). This feedback loop can be the result of the lists and the users of these lists, but also of the recording, sorting and summarizing of this information instantly into intelligence that can send clear messages to companies about the positive and negative aspects of their products, (in)action, and behavior. The feedback loop may also contain the ability to be a two way feedback loop. If consumers vote with their dollars and this data is collected via the systems, methods and technologies talked about in this disclosure, then it is probable that if a notable number of users participate in the process, stark data can tell companies what they are doing right and what consumers would like them to change (B15), (B16), and (B17). If companies are motivated by consumers using these lists, and make changes to their behavior, (in)actions, products, etc., or there are marketplace or industries changes justifying a change in a list, the individual or organizational creators of a list can distribute updates and revisions to the list instantly, rather than having to wait weeks or months for the information to spread though out a group of users that potentially have no contact with each other and don't even know who the others are. Users could be using the updated list within seconds after it has been revised. In some embodiments, every user can also give direct and immediate feedback (in addition to the summary data that is recorded on purchase and avoided purchase transactions) to companies with easy to use interfaces enabling consumers to have their individual voice, video, or written words heard, without having to deal with any of the logistical hassles of contacting a company such as finding an email address, writing a traditional note or letter, finding a number and placing a call (B7) (B9). Data also can be shared with the general public, individual consumers and users, creators of lists, companies, industry groups, government and regulatory bodies in easy to understand formats through a number of traditional and non-traditional methods. Users and creators of lists can make it very simple for any interested party to receive data summaries from particular lists on whatever time interval makes sense and in whatever format makes sense through whatever device or technology makes sense (B11).

Some embodiments use bar code scanning and other technology on mobile and stationary electronic devices combined with databases to empower the consumer from the time they consider a purchase past the fulfillment of that transaction, in order to empower them to make purchases consistent with their consumer wishes and avoid those not in line with their consumer wishes (FIG. 1A) (FIG. 1B) (C7).

An aspect of one embodiment is not just being able to have users understand which products and companies are recommended or not recommended for them, but also to easily and quickly record in real time on a mass scale for the purpose of impacting corporate and market behavior. The system and method may be created for recording and tabulating these actions for every single user, list, organization and combination thereof (FIG. 1A) (FIG. 1C). To successfully do this, user data can be grouped and organized by lists. As was indicated before, anyone can create a list or subscribe to existing lists. The grouping of lists may also important because it is the way by which clear and concise feedback can be given to companies, rather than just the noise of potentially millions of users just supporting or avoiding products and companies without any structure. The data can all be sorted and analyzed using any of the numerous variables in the dataset, but by sorting it by lists and enabling list creators to explain to companies (and to the world) exactly why they were making the purchase decisions they were making (C5) thus offering stated or unstated guidance to the companies, industry groups and others on how to change their behavior.

By offering alternative products (C 2.5) and companies, some embodiments may add an important dimension to the purchase behavior of users. Rather than just having lists telling consumers what not to buy, these lists can offer the potential to consumers to always find what they are looking for and thus can enable them with every transaction to spend their monetary resources on products they are comfortable and happy with. The difference is that this is not just a ‘don't buy’ list—it's instead enabling each user to buy the right product for them, rather than just avoiding the ones that aren't recommended for them. This can be important as it serves as a reward for companies and products that are engaging in behaviors, and producing products that users are happy with. It is not just a matter of some companies losing business or customers. It is a matter of those companies that lost the business being able to have the data to understand exactly who got that lost business and why and using this as an additional encouragement to make a change. If a product a user wants to buy turns out to not be recommended by the list(s) they have subscribed to or have created themselves, understanding the alternative may be as easy as pushing a single button (FIG. 4). List creators can easily be able to create their list of alternative products and companies through a small amount of research and easy to use tools that may suggest comparable products that meet the constraints and recommendations of the list.

In another embodiment, system and method for instantly updating a company or product on a list (B7)(C12) (FIG. 1B) may be provided. Once the authors of a list may decide to make a change to a company or product on their list (such as turning it from recommended to not recommended and adding alternatives), all that may be required is to find that product or company on the list by any number of search parameters, bar codes, etc. and change the product's designation from what it was, to what they want it to be and note any relevant information related to the change if they want to, and then use the easy to use tools to select alternatives if the product was changed from recommended to not recommended. Once the change has been made and confirmed, by the list creator, then a simple button push may distribute it to every user of the list no matter where they are located.

In some implementations, if a user subscribes to more than one list, there is the potential for conflicting recommendations from the two list (for instance one list says to buy product A and the other says not to and to buy product B instead). In one embodiment, a method and system of presenting potential list conflicts to the user for their resolution (FIG. 1D) may be provided. If the two lists have no conflicts then the user may never see the conflict resolution solution (D 2.5). If the two lists have one or more conflicting recommendations, then the reconciliation process begins (D2). The user can be shown, in a simple and easy to understand format what the conflicts are. If there is a product or company similar to the other two in conflict and it is recommended by both lists then the system can make that choice as a default with the user having the right to overrule the system and manually make the choice (D3). If there is no alternative company or product on both lists then the user may be presented with the conflict including the organizational information (D4). The user then can get to decide with an easy to use interface and in many instances with the touch of a button, and then their personal list can be adjusted accordingly and this information can, if the user wishes be shared with the list creators of the two lists without full user identification (D6).

The prevalence of online coupons as well as manufacturers coupons, in store coupons, coupon books, rebates, and other discounts and savings in electronic format can makes it easy for various embodiments to include a system and method for gathering, sorting, and presenting discount coupons, manufacturers' coupons, discount codes, on line and in store-rebates, discounts, and other types of sale offers. The database and the users account can work in conjunction, finding savings for products that the user has on their list and stores the coupons, codes, and other related information in the database and the users account so that when a user buys a recommended or alternative product, available coupons can be made available on the mobile or stationary device—where ever the user is shopping from. The gathering and sorting, and presenting these coupons and other discounts can be a key part of the various embodiments because no coupons may be needed for non-recommended products and the bar codes, product information and other information about the recommended products in a given list may be matched to the bar codes and other information found on the coupons and other discounts. The use of location finding technology may also be applicable because it can enable users to take advantage of in-store coupons and discounts offered by a particular store or set of stores. If a user is in a particular store that has eligible coupons or discounts for products on their list, then these can be presented when and if the user is in the store, and if not if the user is somewhere else. Also the application may present the user with opposing deals and discounts on items in their list so if there are substantial savings on items in the list available through two or more sites or stores, the application can, by analyzing purchase history and other factors, help the consumer make a decision on shopping location.

Everything in this disclosure may apply to enabling both in store and electronic or website purchase transactions as well as the purchase of services, and the contents and inputs of products and services (such as deciding not to buy a certain product because it is made using Iranian oil or not using a particular service because the company gets its oil from a producer or refiner that contributes money to political organizations engaged in misleading or false advertising). Any information about any company, industry, product or service in the world can be entered into the database and a list created by users that others can be invited to subscribe to.

Some embodiments may also include important system and method advances for those with dietary issues or those concerned about the food they purchase. Specifically, come implementations may enable a system and method for integrating nutritional information, ingredients and other information related to food items. Electronic copies of nutritional labels and ingredients may be put into the database in order to make it extremely easy for health care organizations and patients groups to create lists for specific medical conditions, healthy eating, avoiding certain chemicals or additives, etc. All that may be required is for the list creators is to search the electronic database of product nutritional labels and ingredient lists and then the system can assist in building a list of companies and products based on the criteria they select.

Systems and methods, in some embodiments, may be provided for tracking the amount and sources of energy including fossil fuels used in the design, manufacturing, shipment, distribution, storage and sales of individual products and services and linking this information to each product or service and thus enabling individuals and consumers to purchase or avoid products based on these criteria. Using existing active and passive RFID tags, and public and private data about energy shipments, selling, buying, production, refining, distribution and related information, as well as well of origin testing that currently exists today (where oil and other fossil fuels can be tested to locate the source of their origin). Being able to link products and companies to the energy they produce and consume can be possible within the scope of the database and enables users to build their lists based on critical factors that consumers have little or no knowledge of—exactly where the energy came from that the company uses in its products.

As noted before, various embodiments also cover methods and systems for tracking amount of oil and other renewable and non-renewable resources used in the product or service. For products this may mean during its manufacture, its transports, storage, display, sale, purchase, use, and disposal, as well as for the renewable and non-renewable resources actually used in the product (for instance the oil used in the manufacture of plastics). For services, it can include all of the aspects of the service including training, marketing, idle time, completion of service, and follow up.

Everything in this disclosure may also apply to companies that have services instead of products and products that have no bar code, as well as businesses that provide inputs to the production of goods and services. This may include image recognition—using a device to compare and image of the product to those items on a list a consumer has created or subscribed to. Imagine a vegetarian consumer using technology to capture an image of a beef cheeseburger available at restaurant and then various embodiments and its databases and connectivity informing the consumer that this choice should be avoided and suggesting other alternatives in real time.

The database can be used to capture public and non-public data about the companies and services that are offered, and users can add these to their lists and recommend or not recommend them (with alternatives) in a similar fashion to how products are selected. Location related searching can be key to this as is reviews and recommendations from organizations and members of lists.

Users may be able to select from already existing lists or they can create a new list that makes it possible for them to understand whether to purchase a product from a particular company or avoid any product or company on the market based on their specific preferences. These lists may the bar code found on almost all consumer goods as a connecting link to not only the product, but also the company and that company's behavior, actions of the parent company, size of the company, the company's executive team and board members, location, marketplace practices, lobbying efforts, political stance, product ingredients, nutritional content, and thousands of other data points. If a product or company is listed as not recommended on the users list(s) then an alternative products may be suggested that meet the consumer's criteria and are similar to the product or company. If a patient diagnosed with a particular condition which requires dietary restrictions, subscribes to a healthy eating list created specifically for people with that condition and this person scans a particular food not recommended for purchase, a screen indicating that this product is not recommended may appear with a suggestion for a similar product that is recommended by the list. If a product is scanned and it is on the recommended list(s) then the user may simply buys the product and the system can tabulate the resulting purchase. The monetary amounts, products purchased, and other relevant information can be tabulated and can be used to give substantial feedback to companies and entire industries. For example, a list created to support companies who have facilities in a particular state or region, can enable users to support these businesses and also encourages other businesses to set up facilities in the region. Data collected from those lists may be summarized and can be used to make a case for companies to expand their operations within a particular state or region and can encourage other companies without facilities in the area to set them up. Some implementations may enable the bundling of actual consumer behavior and the intent behind it (in the form of both purchases and avoided purchases clearly marked with the reason for the action from the List) of many individual users into a powerful force with the ability to strongly influence corporate and industry behavior in ways that are nearly impossible for individual consumers to do now.

Systems and methods may enable enforcement of boycotts and the ability to apply substantial monetary and consumer pressure on companies based on tabulating the monetary amount of purchases and avoided purchases for each product and company and keeping running totals for each product and company. Every supporter of a cause may now have the power at their fingertips to be as knowledgeable and able to act as the most seasoned leader of the cause. These same systems and methods can also enable the ability to reward and reinforce company actions or behaviors that are viewed as positive or worth rewarding.

The data on the purchase and the avoided purchase as well as offering suggested alternative products that meet the individual's requirements can be key parts of various embodiments, as is the use of price data to quantify the transactions in monetary terms. Also, the ability of some implementations to group users based on lists in order to provide highly relevant information to a particular consumer at any time but especially during the decision making process and the act of purchasing or avoiding purchasing a product and the feedback loop that can be enabled through the data resulting from the List method and system. Additionally, the ability of any individual user or organization to make a list containing companies and products to recommended for purchase and those to avoid, along with the ability to suggest alternative products and companies can be a key feature of some embodiments.

Some embodiments may not constitute theoretical or opinion survey data where consumers are asked to self-assess their present, past or future purchase decisions or criteria. Some embodiments constitute as it happens purchase decision data with consumers' actual purchases and avoided purchases recorded in real time and tracked not just by barcode, product and company, and other logistical information, including the price of the product at the time of purchase or avoided purchase, but also with the reason for the purchase or avoided purchase imbedded with the data directly from the product and company List(s) the consumer is using, and thus extremely clear, and quantifiable intelligence can be presented to companies about what a group of consumers actually does and does not spend its money on and why. For a company that is doing something a specific group of consumers do not like, the message can be clear and can be made in a way that companies understand—by clearly articulating the actual monetary loss in a given time period that resulted from the company's (in)action. For a company that is doing something a group of consumers (List Users) like, clear monetary measurement and an understanding of the actual additional business gained from the company's behavior can be a very useful tool to incentivize the company to continue to engage in this action or behavior.

Some implementations may include auction-like systems and methods that may enable companies selected as alternative products or services that a consumer's list subscriptions have recommended. These auction-like systems and methods can enable consumers to get greater discounts on the products and services recommended to them by allowing the approved alternative companies to bid for the consumer's business by offering discounts, coupons and other deals. So the consumer may gain the benefit of having multiple companies compete for their business, and have the potential to receive a better deal than without the competition. These discounts, deals and savings, can be offered in real time based on the location of the consumer and other demographic information specifically. The companies may enjoy a rare opportunity to switch a customer from the product or service they were in the process of buying to the company's product or service instead. This can offer the chance to start a long term relationship with the customer and so even small items such as a tube of toothpaste represent not just the chance at a selling that product a single time, but potentially gain the customer's business for up to a lifetime not just with the single item, but with all of the products or services the company has for sale. One of the embodiments may comprise having the bidding happen in real time, with discount coupons and credits sent directly to the customer's account, mobile device, computer or other equipment and redeemable immediately.

### Terminology

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently, e.g., through multi-threaded processing, interrupt processing, or multiple processors or processor cores or on other parallel architectures, rather than sequentially.

The various illustrative logical blocks, modules, routines, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The steps of a method, process, routine, or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor having logic circuitry such that the processor can read information from, and write information to, the storage medium. In the alternative, the storage medium can be integral to the processor. The processor and the storage medium can reside in an application-specific integrated circuit (ASIC), field-programmable gate array (FPGA), and the like. The ASIC, FPGA, etc. can reside in a user terminal. In the alternative, the processor and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Conjunctive language such as the phrase “at least one of X, Y and Z,” unless specifically stated otherwise, is to be understood with the context as used in general to convey that an item, term, etc. may be either X, Y or Z. Thus, such conjunctive language is not generally intended to imply that certain embodiments require at least one of X, at least one of Y and at least one of Z to each be present.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments of the inventions described herein can be embodied within a form that does not provide all of the features and benefits set forth herein, as some features can be used or practiced separately from others. The scope of certain inventions disclosed herein is indicated by the appended claims rather than by the foregoing description. All changes which come within the meaning and range of equivalency of the claims are to be embraced within their scope.

### Conclusion

Systems and methods can provide the mechanisms to enable individuals to become highly informed consumers with regard to their purchases everywhere, including directly at the point of purchase, and allows them to fully assert their powers of consumer choice on each product purchase they consider. Some embodiments can also enable consumers to provide companies and entire industries direct and clear feedback on why they purchased certain products and avoided others. Additionally, some embodiments may enable consumers with similar purchase decision criteria to virtually pool their feedback without ever having to organize, meet each other, or interact in any way, thus companies can be presented with organized and structured data from many consumers, explaining exactly why they did or did not purchase their company's product(s).

In some embodiments, disclosed systems and methods can enable individuals to become highly informed consumers with regard to their purchases, including directly at the point of purchase, and can allow them to fully assert their powers of consumer choice on each product or service purchase they consider. Various embodiments also enable consumers to provide individual companies and entire industries direct and clear feedback on why consumers purchased certain products or services and avoided others. Additionally, various embodiments may enable consumers with similar purchase decision criteria to consolidate and summarize their feedback without ever having to organize, meet each other, or interact in any way. Companies can be presented with organized and structured data from many consumers, explaining exactly why they did or did not purchase the company's product(s)/services and can be clearly organized so it is clear to a company that X number of people chose or did not choose these product(s) during Y period of time for Z reason resulting in Q dollars of actual or lost sales (where XYZ and Q are all actual variables based on each unique list of products and companies). In some embodiments, disclosed systems and methods advantageously can serve as a marketplace for like-minded consumers and companies to find each other with reduced effort and/or hassle. This can substantially empower consumers and lower the companies' customer acquisition costs.

What is claimed is:

1. A purchasing recommendation apparatus comprising:
a memory module configured to store a recommended products or services list; and
a processor comprising logic circuitry, the processor configured to:
receive an identification of a desired product or service;
in response to determining that 1) the identified product or service is comprised in the recommended products or services list and 2) the identified product or service was purchased:
selectively generate one or more electronic coupons, and
update the recommended products or services list with information corresponding to the purchased identified product or service; and
in response to determining that the identified product or service is not comprised in the recommended products or services list:
provide a user interface comprising a set of alternative products or services based at least in part on a set of preferences, and
in response to determining that an alternative product or service from the set was purchased, update the recommended products or services list with information corresponding to the purchased alternative product or service.

2. The apparatus of claim 1, wherein the identification is based at least in part on at least one of bar code scanning, RFID, GPS, package recognition, and image recognition.

3. The apparatus of claim 1, wherein the processor is further configured to in response to determining that the identified product or service is not comprised in the recommended products or services list:
update an avoided purchases or services list with information corresponding to the identified product or service.

4. The apparatus of claim 3, wherein:
information corresponding to the identified product or service comprises at least one of quantity purchased, purchase price, and seller information; and
information corresponding to the alternative product or service comprises at least one of quantity purchased, purchase price, and seller information.

5. The apparatus of claim 1, wherein the processor is further configured to in response to determining that the identified product or service is not comprised in the recommended products or services list:
in response to determining that the identified product or service was purchased, update the recommended products or services list with information corresponding to the purchased identified product or service.

6. The apparatus of claim 1, wherein the processor is further configured to transmit the recommended products or services list to a receiver.

7. The apparatus of claim 1, wherein the processor is configured to selectively generate the one or more coupons by:
in response to determining that the identified product or service was purchased or was being considered for purchase, generating the one or more coupons associated with the identified product or service; and
in response to determining that a product or service different from the identified product or service was purchased, generating the one or more coupons associated with the different product or service in response to determining that the different product or service is comprised in the recommended products or services list.

8. The apparatus of claim 1, wherein the processor is further configured to, in response to determining that identified product or service is not comprised in the recommended products or services list:
in response to determining that an alternative product or service that is not included in the set of alternative products or services was purchased, update the recommended products or services list with information corresponding to the purchased alternative product or service.

9. The apparatus of claim 1, wherein the processor is further configured to provide a user interface for receiving feedback associated with a purchased product or service and receive feedback associated with the purchased product or service.

10. The apparatus of claim 1, wherein the memory module is configured to store another recommended products or services list and the processor is further configured to:
in response to determining that the identified product or service is comprised in the recommended products or services list and is not comprised in another recommended products or services list:
in response to determining that the recommended products or services list and another recommended products or services list include the same alternative product or service, provide a user interface comprising the alternative product or service; and
in response to determining that the recommended products or services list and another recommended products or services list do not include the same alternative product or service, provide a user interface for purchasing an alternative product or service, and update at least one of the recommended products or services list and another recommended products or services list with information associated with the alternative product or service.

11. The apparatus of claim 1, wherein the one or more coupons comprise one or more of electronic coupons and user specific coupons, wherein a user specific coupon is configured to be nontransferable and is further configured to change value based on one or more purchases made using the user specific coupon.

12. A purchasing recommendation method comprising:
receiving an identification of a desired product or service from a computing device;
in response to determining that 1) the identified product or service is comprised in an electronic recommended products or services list and 2) the identified product or service was purchased:
selectively generating one or more electronic coupons, and
updating the recommended products or services list with information corresponding to the purchased identified product or service; and
in response to determining that the identified product or service is not comprised in the recommended products or services list:
providing a user interface comprising a set of alternative products or services based at least in part on a set of preferences, and
in response to determining that an alternative product or service from the set was purchased, updating the recommended products or services list with information corresponding to the purchased alternative product or service,
wherein the method is performed by a processor comprising logic circuitry.

13. The method of claim 12, wherein the identification is based at least in part on at least one of bar code scanning, RFID, GPS, package recognition, and image recognition.

14. The method of claim 12, wherein the identification is based at least in part on information received from an Internet website or application.

15. The method of claim 12, further comprising in response to determining that the identified product or service is not comprised in the recommended products or services list:
updating an avoided purchases or services list with information corresponding to the identified product or service.

16. The method of claim 15, wherein:
information corresponding to the identified product or service comprises at least one of quantity purchased, purchase price, and seller information; and
information corresponding to the alternative product or service comprises at least one of quantity purchased, purchase price, and seller information.

17. The method of claim 12, further comprising in response to determining that the identified product or service is not comprised in the recommended products or services list:
in response to determining that the identified product or service was purchased, updating the recommended products or services list with information corresponding to the purchased identified product or service.

18. The method of claim 12, further comprising transmitting the recommended products or services list to a receiver.

19. The method of claim 12, wherein selectively generating the one or more coupons comprises:
in response to determining that the identified product or service was purchased or was being considered for purchase, generating the one or more coupons associated with the identified product or service; and
in response to determining that a product or service different from the identified product or service was purchased, generating the one or more coupons associated with the different product or service in response to determining that the different product or service is comprised in the recommended products or services list.

20. The method of claim 12, further comprising, in response to determining that identified product or service is not comprised in the recommended products or services list:
in response to determining that an alternative product or service that is not included in the set of alternative products or services was purchased, updating the recommended products or services list with information corresponding to the purchased alternative product or service.

21. The method of claim 12, further comprising providing a user interface for receiving feedback associated with a purchased product or service and receive feedback associated with the purchased product or service.

22. The method of claim 12, further comprising:
in response to determining that the identified product or service is comprised in the recommended products or services list and is not comprised in another recommended products or services list:
in response to determining that the recommended products or services list and another recommended products or services list include the same alternative product or service, providing a user interface comprising the alternative product or service; and
in response to determining that the recommended products or services list and another recommended products or services list do not include the same alternative product or service, providing a user interface for purchasing an alternative product or service, and updating at least one of the recommended products or services list and another recommended products or services list with information associated with the alternative product or service.

23. The method of claim 12, wherein the recommended products or services list is based at least in part on energy resources needed for providing a product or service.
